(19) United States
(12) Patent Application Publication
(10) Pub. No.: US 2026/0087686 A1
(43) Pub. Date: Mar. 26, 2026

(54) VIRTUAL SPACE CONTROL SYSTEM, AND VIRTUAL SPACE CONTROL METHOD

(71) Applicant: JVCKENWOOD Corporation, Yokohama-shi (JP)

(72) Inventor: Yuya Takehara, Yokohama-shi (JP)

(21) Appl. No.: 19/338,194

(22) Filed: Sep. 24, 2025

(30) Foreign Application Priority Data
Sep. 24, 2024 (JP) 2024-165050
Sep. 24, 2024 (JP) 2024-165499

(51) Int. Cl. G06T 11/00; G06F 3/14

(52) U.S. Cl. CPC G06T 11/00; G06F 3/1454

(57) ABSTRACT

A virtual space control system includes a control device that places, in a virtual space, a first avatar of a first user, who uses a first terminal in the real space, and a second avatar of a second user, who uses a second terminal in the real space; that, while the first avatar and the second avatar are placed in the virtual space, when a conversation between the first user and the second user in the real space is detected, generates, in the virtual space, an enclosing region which encloses the first avatar and the second avatar; and that displays the virtual space in display units of terminal devices including the first terminal device and the second terminal device.

### CROSS-REFERENCE TO RELATED APPLICATIONS

This application is based upon and claims the benefit of priority from Japanese Patent Applications No. 2024-165050 and No. 2024-165499, both filed on September 24, 2024, the entire contents of all of which are incorporated herein by reference.

### BACKGROUND OF THE INVENTION

### 1. Field of the Invention

The present invention relates to a virtual space control system, a virtual space control method, and a computer program product.

### 2. Description of the Related Art

A technology is known by which a user of a terminal device uses an avatar in a virtual space (for example, refer to Japanese Patent Application Laid-open No. 2022-103906).

In a virtual space as mentioned above, there are times when a user finds it difficult to understand the communication happening among avatars, such as which avatar is communicating with which avatar.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A virtual space control system according to the present disclosure comprising a control device that places, in a virtual space, a first avatar of a first user, who uses a first terminal in real space, and a second avatar of a second user, who uses a second terminal in the real space, while the first avatar and the second avatar are placed in the virtual space, when a conversation between the first user and the second user in the real space is detected, generates, in the virtual space, an enclosing region which encloses the first avatar and the second avatar, and displays the virtual space in display units of terminal devices including the first terminal device and the second terminal device.

A virtual space control method implemented by a control device according to the present disclosure, comprising: placing, in a virtual space, a first avatar of a first user, who uses a first terminal in real space, and a second avatar of a second user, who uses a second terminal in the real space; generating that, while the first avatar and the second avatar are placed in the virtual space, when a conversation between the first user and the second user in the real space is detected, includes generating, in the virtual space, an enclosing region which encloses the first avatar and the second avatar; and

displaying the virtual space in display units of terminal devices including the first terminal device and the second terminal device.

A computer program product according to the present disclosure having a computer readable medium including a virtual space control program, wherein the virtual space control program, when executed by a computer, causes the computer to execute: placing, in a virtual space, a first avatar of a first user, who uses a first terminal in real space, and a second avatar of a second user, who uses a second terminal in the real space; generating that, while the first avatar and the second avatar are placed in the virtual space, when a conversation between the first user and the second user in the real space is detected, includes generating, in the virtual space, an enclosing region which encloses the first avatar and the second avatar; and displaying the virtual space in display units of terminal devices including the first terminal device and the second terminal device.

A virtual space control system according to the present disclosure comprising a control device that places, in a virtual space, a first avatar of a first user, who uses a first terminal in real space, and a second avatar of a second user, who uses a second terminal in the real space, while the first avatar and the second avatar are placed in the virtual space, when a conversation between the first user and the second user in the real space is detected, changes distance between the first avatar and the second avatar from distance before detection of the conversation, displays the virtual space in display units of terminal devices including the first terminal device and the second terminal device.

A virtual space control method implemented by a control device according to the present disclosure, comprising: placing, in a virtual space, a first avatar of a first user, who uses a first terminal in real space, and a second avatar of a second user, who uses a second terminal in the real space; changing that, while the first avatar and the second avatar are placed in the virtual space, when a conversation between the first user and the second user in the real space is detected, includes changing distance between the first avatar and the second avatar from distance before detection of the conversation; displaying the virtual space in display units of terminal devices including the first terminal device and the second terminal device.

A computer program product according to the present disclosure having a computer readable medium including a virtual space control program, wherein the virtual space control program, when executed by a computer, causes the computer to execute: placing, in a virtual space, a first avatar of a first user, who uses a first terminal in real space, and a second avatar of a second user, who uses a second terminal in the real space; changing that, while the first avatar and the second avatar are placed in the virtual space, when a conversation between the first user and the second user in the real space is detected, includes changing distance between the first avatar and the second avatar from distance before detection of the conversation; displaying the virtual space in display units of terminal devices including the first terminal device and the second terminal device.

### BRIEF DESCRIPTION OF THE DRAWINGS

FIG. 1 is a schematic diagram illustrating an exemplary configuration of a virtual space control system;

FIG. 2 is a block diagram illustrating an exemplary configuration of a terminal device;

FIG. 3 is a block diagram illustrating an exemplary configuration of a server device;

FIG. 4 is a functional block diagram illustrating an example of a control device;

FIG. 5 is a flowchart for explaining an example of a virtual space control method;

FIGS. 6 to 9 are diagrams illustrating an example of the virtual space displayed in a display unit of the terminal device;

FIG. 10 is a diagram illustrating an example of the correspondence relation of the types of conversation between a first user and a second user with the distances between a first avatar and a second avatar; and

FIGS. 11 and 12 are diagrams illustrating an example of the virtual space displayed in the display unit of the terminal device.

### DETAILED DESCRIPTION OF THE PREFERRED EMBODIMENTS

An exemplary embodiment of a virtual space control system, a virtual space control method, and a computer program product according to the present invention is described below with reference to the accompanying drawings. However, the present invention is not limited by the embodiment described below. Moreover, the constituent elements explained in the embodiment include the constituent elements that are simple and replaceable by a person skilled in the art, or include practically identical constituent elements.

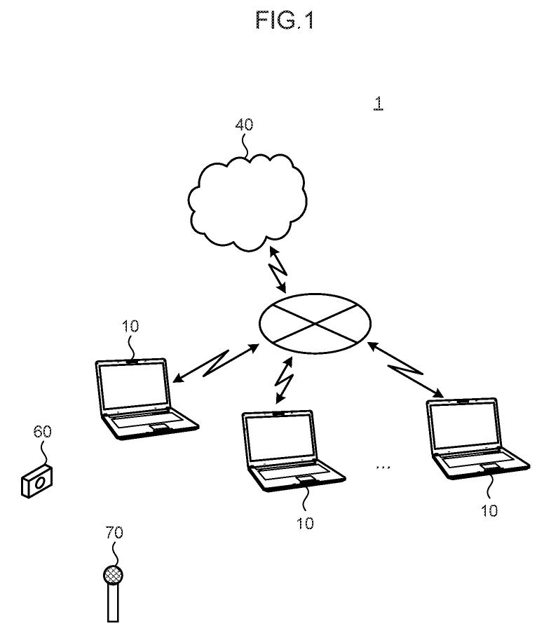

FIG. 1 is a schematic diagram illustrating an exemplary configuration of a virtual space control system. A virtual space control system 1 controls a virtual space V. The virtual space V is a virtually-configured space in which users can log in using terminal devices 10 (explained later). In the virtual space V, an avatar of each logged-in user is placed.

In the following explanation, a "user" is appropriately referred to as a "first user", and a user who performs communication such as a conversation with the first user is referred to as a "second user". Moreover, a user other than a first user and a second user is sometimes referred to as a third user. The terminal device that is used for logging in to the virtual space V by a first user is sometimes referred to as a first terminal device. The terminal device that is used for logging in to the virtual space V by a second user is sometimes referred to as a second terminal device. The terminal device that is used for logging in to the virtual space V by a third user is sometimes referred to as a third terminal device. A first terminal device is an arbitrary terminal device logged in to the virtual space V. A second terminal device is a different terminal device than the first terminal device, and is an arbitrary terminal device logged in to the same virtual space V in which the first terminal device has logged in to. A third terminal device is a different terminal device than the first terminal device and the second terminal device, and is an arbitrary terminal device logged in to the same virtual space V in which the first terminal device and the second terminal device have logged in to.

The virtual space control system 1 includes terminal devices 10 and a server device 40. The terminal devices 10 are used by the users for work and in daily life, and are logged in to the virtual space V.

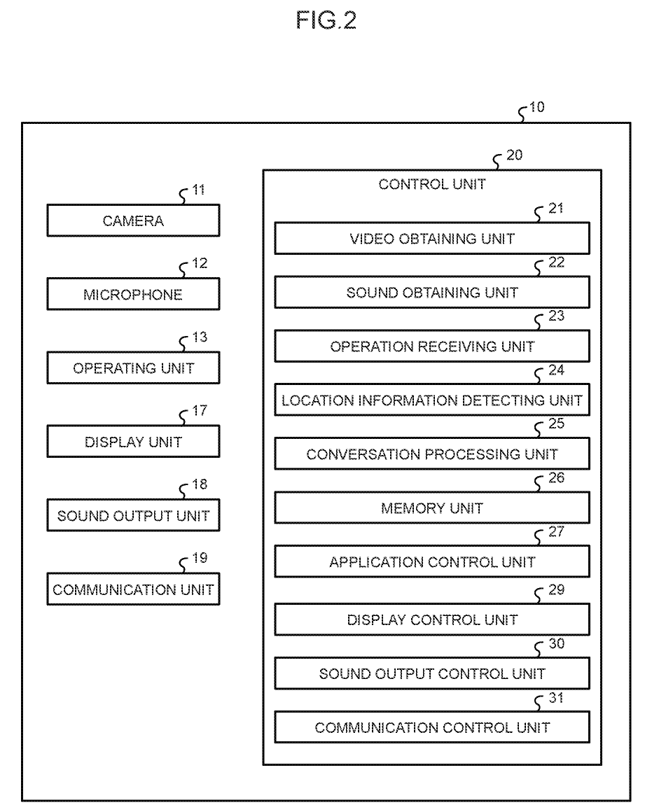

FIG. 2 is a block diagram illustrating an exemplary configuration of a terminal device. Each terminal device 10 is an information terminal device such as a personal computer, a smartphone, a tablet terminal, or a wearable device such as a head-up display. The terminal devices 10 are connected to the server device 40 via a network and are able to perform data communication with the server device 40.

The terminal device 10 includes a camera 11, a microphone 12, an operating unit 13, a display unit 17, a sound output unit 18, a communication unit 19, and a control unit 20.

The camera 11 is capable of taking a video of, for example, the user of the terminal device 10 and the surrounding of the user. Then, the camera 11 outputs the taken video to a video obtaining unit 21 of the control unit 20.

The microphone 12 records the surrounding sounds of the terminal device 10. The microphone 12 records the sounds from the direction facing the display unit 17 of the terminal device 10. The microphone 12 can be installed in a headset connected to the terminal device 10. The microphone 12 records the voices uttered by the user of the terminal device 10 and records the surrounding sounds of the terminal device 10. For example, the microphone 12 records the voices of the first user and the second user. Then, the microphone 12 outputs the information related to the recorded sounds to a sound obtaining unit 22 of the control unit 20.

The operating unit 13 is an input device to which various operations with respect to the terminal device 10 can be input. Then, the operating unit 13 outputs an operation signal, which corresponds to an input operation, to an operation receiving unit 23. The operating unit 13 includes, for example, a keyboard, or a mouse, or a touch-sensitive panel placed over the display unit 17, or buttons, or switches. For example, the operating unit 13 is capable of receiving a key input operation, a click operation, or a touch operation. The operating unit 13 can include the microphone 12. Thus, using the microphone 12, the operating unit 13 records the sound related to an operation and outputs the recorded sound to the operation receiving unit 23.

Moreover, the operating unit 13 is capable of receiving, on the display screen of the display unit 17, an arbitrary operation with respect to the avatar of the concerned user in the virtual space V.

The display unit 17 displays a variety of information containing characters and images. For example, the display unit 17 is a display including a liquid crystal display or an organic electro-luminescence (EL) display. The display unit 17 displays, for example, the avatar of each user in the virtual space V. The display in the display unit 17 is controlled by a display control unit 29 of the control unit 20.

The sound output unit 18 outputs various sounds coming from the terminal device 10. The sound output unit 18 is implemented using, for example, a speaker. For example, when the user is using the virtual space V, the sound output unit 18 outputs the surrounding sounds of the avatar of the concerned user in the virtual space V. The output of sounds from the sound output unit 18 is controlled by a sound output control unit 30 of the control unit 20.

The communication unit 19 is configured to perform wired communication or wireless communication. The communication unit 19 performs communication according to a communication method in which, for example, Wi-Fi (registered trademark) or a telecommunications line is used, and establishes connection with an intranet or the Internet. The communication performed by the communication unit 19 is controlled by a communication control unit 31. The communication unit 19 communicates videos and sounds with the server device 40 as well as performs data communication of operation information of applications. Moreover, with the server device 40, the communication unit 19 performs data communication of account information of the user who has logged in to the terminal device 10 and operating status information of applications.

The control unit 20 controls the constituent elements of the terminal device 10. For example, the control unit 20 includes a control device such as a central processing unit (CPU) or a micro processing unit (MPU), and includes a storage device such as a random access memory (RAM) or a read only memory (ROM). The control unit 20 executes a computer program meant for controlling the operations of the terminal device 10 according to the application concerned. Alternatively, for example, the control unit 20 can be implemented using an integrated circuit such as an application specific integrated circuit (ASIC) or a field programmable gate array (FPGA). The control unit 20 loads the stored computer program into a memory, and executes the commands written in the computer program. The control unit 20 includes an internal memory such as a RAM used for temporarily storing the data in the control unit 20. Meanwhile, the control unit 20 can also be implemented by combining hardware and software.

The control unit 20 includes the video obtaining unit 21, the sound obtaining unit 22, the operation receiving unit 23, a location information detecting unit 24, a conversation processing unit 25, a memory unit 26, an application control unit 27, the display control unit 29, the sound output control unit 30, and the communication control unit 31 as the function blocks implemented using circuits or as a result of executing a computer program.

The video obtaining unit 21 obtains the videos taken by the camera 11. More specifically, the video obtaining unit 21 obtains a video taken by the camera 11 and capturing the user who is using the terminal device 10. The video data obtained as a result of the imaging performed by the camera 11 represents dynamic images. Meanwhile, alternatively, the video obtaining unit 21 can obtain the videos taken by an external camera 60 (see FIG. 1) that is different than the camera 11.

The sound obtaining unit 22 obtains the sounds detected by the microphone 12. The sound obtaining unit 22 obtains the voices uttered by the users who are present around the terminal device 10. For example, the sound obtaining unit 22 obtains the voices of the first user and the second user. Meanwhile, alternatively, the sound obtaining unit 22 can obtain the sounds detected by an external microphone 70 (see FIG. 1) that is different than the microphone 12.

The operation receiving unit 23 obtains, from the operating unit 13, an operation signal corresponding to an operation with respect to the operating unit 13. Then, the operation receiving unit 23 outputs a control signal corresponding to the obtained operation signal to the constituent elements.

The operation receiving unit 23 receives operations with respect to the display screen of the display unit 17. For example, the operation receiving unit 23 receives, on the display screen of the display unit 17, an operation of moving the avatar of the concerned user in the virtual space V. For example, the operation receiving unit 23 receives an operation by which, on the display screen of the display unit 17, the avatar of the concerned user is either overlapped on the avatar of another person or kept adjacent to the avatar of the other person in the virtual space V.

The location information detecting unit 24 detects the location information, in the real space, of the user of the terminal device 10. The location information, in the real space, of the user of the terminal device 10 can be treated as the location information, in the real space, of the terminal device 10.

The location information detecting unit 24 can obtain the location information of each terminal device inside an office in the real space using, for example, a variety of systems such as the real time location system (RTLS) capable of measuring the inhouse location with high accuracy. According to the RTLS, for example, each terminal device has a tag assigned thereto, the communication is performed using the ultrawide band (UWB), and the location information of the tags is measured using the TDoA method (TDoA stands for Time Difference of Arrival).

The conversation processing unit 25 detects a conversation made by the user. The conversation processing unit 25 obtains the sounds from the sound obtaining unit 22, and detects whether or not a conversation is included in the sounds. When a conversation is included in the sounds, the conversation processing unit 25 detects that conversation. For example, the conversation processing unit 25 can detect a conversation between a first user and a second user in the real space. The conversation processing unit 25 can detect a conversation by detecting that the sounds obtained by the sound obtaining unit 22 include, in an alternate manner, the voices of a plurality of speakers. The sound obtaining unit 22 can separately obtain a voice A, which is obtained from the terminal device 10A, and a voice B, which is obtained from the terminal device 10B. Then, the conversation processing unit 25 compares the voices A and B that are obtained by the sound obtaining unit 22, and can detect a conversation by detecting the fact that the voice B is included in the voice A.

For example, from the obtained sounds, the conversation processing unit 25 detects the manner of speaking of the users, the tone of voice of the users, and the phrases and the words used; and recognizes the content of the conversation based on the detection result. For example, the conversation processing unit 25 can recognize whether the user is talking in a formal manner, or whether the user is talking in a casual manner, or whether the content of the conversation indicates work-related topics, or whether the content of the conversation indicate private topics. Meanwhile, the conversation processing unit 25 can include a machine learning model in which, for example, a detected conversation and the content of the recognized conversation are machine-learnt in a corresponding manner. The machine learning model can be set in such a way that, when a detected conversation is input, the content of that input conversation are output. Moreover, using a known technology such as speaker diarization for estimating the speaker from the sounds, if it is estimated from the sounds that a plurality of speakers is present, the conversation processing unit 25 can detect that a conversation is included and can recognize the content of the conversation of each speaker.

The memory unit 26 stores therein, for example, the arithmetic operation details of the control unit 20 and information such as computer programs. For example, the memory unit 26 is configured using a main memory device such as a RAM and a ROM or using a storage device such as a solid state drive (SSD) or a hard disk drive (HDD).

In the memory unit 26 are stored, for example, computer programs and setting information related to the applications used in the terminal device 10, such as an application for the virtual space V. Moreover, in the memory unit 26, the types of conversations as classified by the conversation processing unit 25, correspondence information (explained later), and a machine learning model for recognizing the content of the conversation are stored in advance.

The application control unit 27 controls the operations of various applications that are run in the terminal device 10. The application control unit 27 can control various applications in cooperation with an application control unit 44 of the server device 40 (explained later).

The application control unit 27 uses the display control unit 29 (explained layer) to perform, in the display unit 17, the display about the applications running in the terminal device 10. The display about the applications implies display screens, such as windows, or icons to be shown to the user of the terminal device 10.

When the user of the terminal device 10 is logged in to the virtual space V, the application control unit 27 enables usage of the virtual space V, which is being run by the application control unit 44 of the server device 40, in the terminal device 10.

The display control unit 29 controls the display of a variety of information in the display unit 17 of the terminal device 10. The display control unit 29 controls the display of the videos of the virtual space V in the display unit 17.

The sound output control unit 30 controls the output of the sounds from the sound output unit 18. The sound output control unit 30 causes the sound output unit 18 to output the sounds such as the utterances in a conversation happening in the virtual space V.

The communication control unit 31 controls the communication unit 19 so as to control the communication of data such as videos and sounds with the server device 40 and to control the communication of operating condition information about the applications. More specifically, for example, the communication control unit 31 controls the communication unit 19 and receives videos and sounds of the virtual space V from the server device 40. For example, the communication control unit 31 controls the communication unit 19 and sends, to the server device 40, the video and the voice of the user, who is facing the display unit 17 of the terminal device 10, as obtained by the video obtaining unit 21 and the sound obtaining unit 22. The operating condition information of an application is, for example, the information, in a virtual space application that implements the virtual space control system 1, about the manner in which the operating unit 13 operates the avatar. Moreover, the communication control unit 31 sends, to the server device 40, the information indicating the location information detected by the location information detecting unit 24.

Meanwhile, the operations performed by the control unit 20 can alternatively be performed by a different control device other than the terminal device 10.

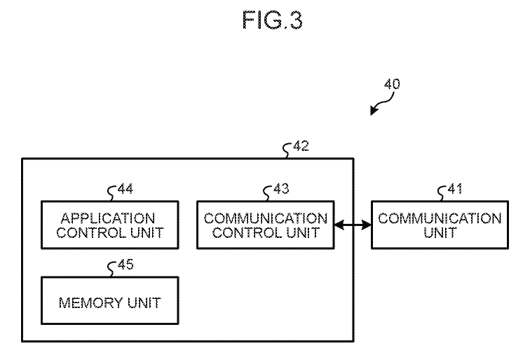

FIG. 3 is a block diagram illustrating an exemplary configuration of the server device. The server device 40 provides the service of making the virtual space V available for use. The server device 40 can be a general-purpose server device including a distributed server. The server device 40 builds and controls the virtual space V. The server device 40 includes a communication unit 41 and a server control unit 42.

The communication unit 41 is configured to perform wired communication or wireless communication. The communication unit 41 performs communication according to a communication method in which, for example, Wi-Fi (registered trademark) or a telecommunications line is used, and establishes connection with an intranet or the Internet. The communication performed by the communication unit 41 is controlled by a communication control unit 43. The communication unit 41 communicates videos and sounds with a plurality of terminal devices 10 as well as performs data communication of the operating condition information of applications.

The server control unit 42 controls the constituent elements of the server device 40. For example, the server control unit 42 includes a control device such as a CPU or an MPU, and includes a storage device such as a RAM or a ROM. Alternatively, for example, the server control unit 42 can be implemented using an integrated circuit such as an ASIC or an FPGA. Still alternatively, the server control unit 42 can also be implemented by combining hardware and software. The server control unit 42 executes a computer program meant for controlling the operations of the server device 40 according to the application concerned.

The server control unit 42 includes the communication control unit 43, the application control unit 44, and a memory unit 45 as the function blocks implemented using circuits or as a result of executing a computer program.

The communication control unit 43 controls the communication unit 41 so as to control the communication of data including videos and audios with the terminal device 10 and to control the communication of the operating condition information about the applications. For example, the communication control unit 43 controls the communication unit 41 so that, from the terminal device 10, videos taken either by the camera 11 of the terminal device 10 or by the external camera 60 are received and sounds recorded either by the microphone 12 or by the external microphone 70 are received. For example, the communication control unit 43 controls the communication unit 41 and sends the video and the sounds of the virtual space V to the terminal device 10. The operating condition information of the application is, for example, the information constituting the virtual space application.

The application control unit 44 controls the operations of various applications running in the server device 40. For example, the application control unit 44 controls the operation of the application for the virtual space V.

The memory unit 45 stores therein, for example, the arithmetic operation details of the server control unit 42 and information such as computer programs. For example, the memory unit 45 is configured using a main memory device such as a RAM and a ROM or using a storage device such as an SSD or an HDD.

The memory unit 45 stores therein the information constituting the virtual space V. In the present embodiment, for each user who logs in to the virtual space V; the avatar of that user, the terminal device 10 corresponding to that avatar, and the information indicating the account holder of that terminal device 10 are stored in the memory unit 45. For example, in the memory unit 45 is stored the information indicating the placement of objects constituting the virtual space V, such as the sections and the desks constituting the virtual space V.

The virtual space control system 1 includes a control device 50. The control device 50 is a conceptual device implemented using at least one device from among a plurality of terminal devices 10 and the server device 40 that constitute the virtual space control system 1. That is, from among the functions of the control device 50 as explained below, at least one function can be implemented in the terminal device 10 (for example, the memory unit 26 or the application control unit 27), and at least one function can be implemented in the server device 40 (for example, the memory unit 45 or the application control unit 44).

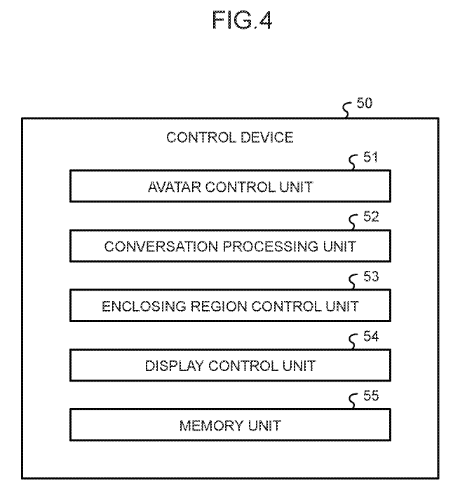

FIG. 4 is a functional block diagram illustrating an example of the control device 50. As illustrated in FIG. 4, the control device 50 includes an avatar control unit 51, a conversation processing unit 52, an enclosing region control unit 53, a display control unit 54, and a memory unit 55.

The avatar control unit 51 places, in the virtual space, the avatar of the user who uses the terminal device 10 in the real space. The avatar control unit 51 controls the state of the avatar, such as the placement, the orientation, and the behavior in the virtual space. For example, the avatar control unit 51 places, in the virtual space V, a first avatar of a first user who uses a first terminal 10 in the real space, and a second avatar of a second user who uses a second terminal 10 in the real space. Moreover, the avatar control unit 51 can change the distances among a plurality of avatars in the virtual space. In the state in which a first avatar and a second avatar are placed in the virtual space V, when a conversation between the corresponding first user and the corresponding second user is detected, the avatar control unit 51 changes the distance between the first avatar and the second avatar from the distance before the detection of the conversation. Meanwhile, in the memory unit 55, it is possible to store, in advance, correspondence information T in which the types of conversation are held in a corresponding manner to the distances between the first avatar and the second avatar. In that state, while the first avatar A1 and the second avatar A2 are placed in the virtual space V, when a conversation between the first user and the second user in the real space is detected, the avatar control unit 51 detects the type of conversation based on the processing result obtained by the conversation processing unit 52; obtains the distance corresponding to the detected type of conversation based on the correspondence information; and changes the distance between the first avatar and the second avatar to the obtained distance. Regarding the detailed functions of the avatar control unit 51, the explanation is given later.

The conversation processing unit 52 determines whether or not a plurality of users of the terminal devices 10 in the real space is having a conversation in reality. When it is determined that a plurality of users is having a conversation in reality, the conversation processing unit 52 determines, based on the content of the conversation, whether or not a third person different than the plurality of users is involved in the conversation.

The enclosing region control unit 53 controls the state of the virtual space. The enclosing region control unit 53 forms, in the virtual space, an enclosing region for enclosing a plurality of avatars. While a first avatar and a second avatar are placed in the virtual space V, when a conversation between the corresponding first user and the corresponding second user in the real space is detected, the enclosing region control unit 53 generates an enclosing region AR in the virtual space V for enclosing the first avatar and the second avatar. Moreover, when a third user is detected who is related to the content of the conversation between the first user and the second user, and when it is detected that a third avatar of the third user is placed in the virtual space V, the enclosing region control unit 53 places the third avatar close to the enclosing region, and modifies the enclosing region in such a way that at least some part of the enclosing region gets closer to the third avatar. Regarding the detailed functions of the enclosing region control unit 53 and regarding the details of the enclosing region, the explanation is given later.

The display control unit 54 displays, in the display unit 17 of the terminal device 10, the processing result obtained by the avatar control unit 51 and the enclosing region control unit 53.

The memory unit 55 stores therein the data and a computer program meant for executing the operations of the control device 50. Moreover, in the memory unit 55, it is possible to store correspondence information in which the type of conversation between a first user and a second user is held in a corresponding manner to the distance between the first avatar and the second avatar.

The memory unit 55 stores therein a virtual space control program that causes a computer to execute: an operation of placing a first avatar A1 of a first user, who uses a first terminal device 10 in the real space, in the virtual space V and placing a second avatar A2 of a second user, who uses a second terminal device 10 in the real space, in the virtual space V; an operation by which, while the first avatar A1 and the second avatar A2 are placed in the virtual space V, when a conversation between the first user and the second user in the real space is detected, the enclosing region AR that encloses the first avatar A1 and the second avatar A2 is generated in the virtual region V; and an operation of displaying the virtual space V in the display units of the terminal devices including the first terminal device 10 and the second terminal device 10.

Moreover, the memory unit 55 stores therein a virtual space control program that causes a computer to execute: an operation of placing a first avatar A1 of a first user, who uses a first terminal device 10 in the real space, in the virtual space V and placing a second avatar A2 of a second user, who uses a second terminal device 10 in the real space, in the virtual space V; an operation by which, while the first avatar A1 and the second avatar A2 are placed in the virtual space V, when a conversation between the first user and the second user in the real space is detected, the distance between the first avatar A1 and the second avatar A1 is changed from the distance before the detection of the conversation; and an operation of displaying the virtual space V in the display units of the terminal devices including the first terminal device 10 and the second terminal device 10.

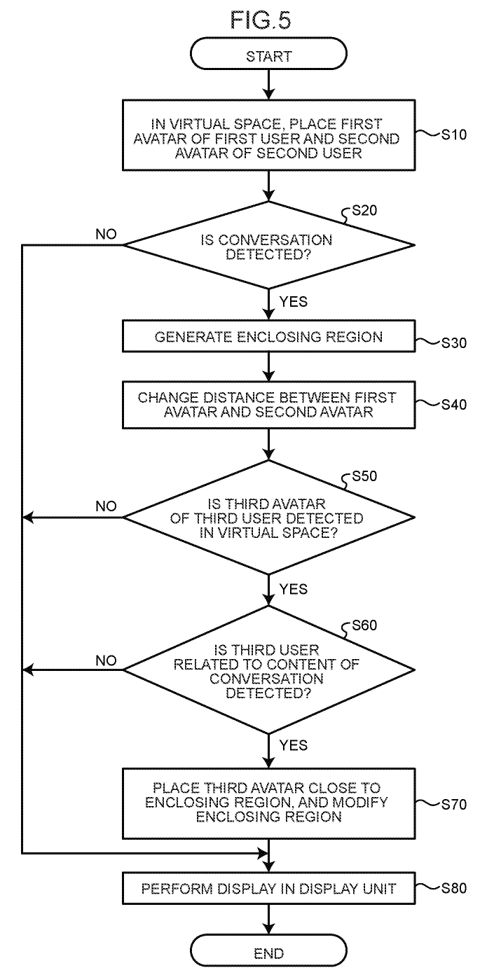

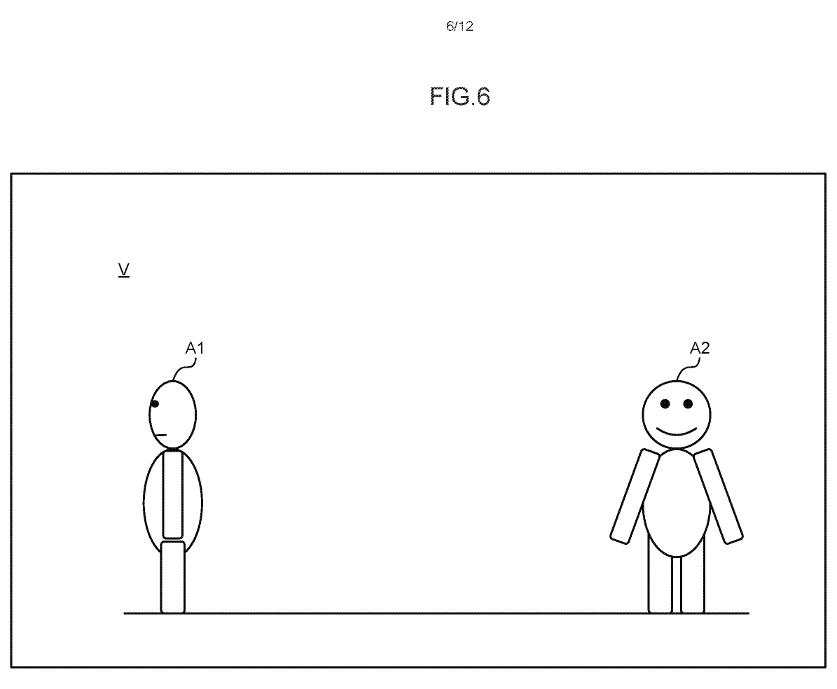

Given below is the explanation of the virtual space control method according to the present embodiment. FIG. 5 is a flowchart for explaining an example of the virtual space control method. FIGS. 6 to 9 are diagrams illustrating an example of the virtual space displayed in the display unit 17 of the terminal device 10.

When a user uses the corresponding terminal device 10 to access the server device 40 and operates the operating unit 13 to log in to the virtual space V, the operation details are sent from the communication unit 19 to the server device 40. In the server device 40, based on the information sent from the terminal device 10, the application control unit 44 performs the login operation for the user.

In the control device 50, the avatar control unit 51 places, in the virtual space V, the avatar of the user who has logged in to the virtual space V. The following explanation is given with reference to an example in which a first user who uses one terminal device in the real space (hereinafter, referred to as a first terminal device) and a second user who uses another terminal device in the real space (hereinafter, referred to as a second terminal device) log in to the virtual space V. In that case, as illustrated in FIG. 6, the avatar control unit 51 places the first avatar A1 of the first user and the second avatar A2 of the second user in the virtual space V (Step S10).

While the first avatar A1 and the second avatar A2 are placed in the virtual space V, the conversation processing unit 52 determines whether or not a conversation between the first user and the second user in the real space is detected (Step S20). At Step S20, for example, when a video capturing a conversation between the first user and the second user is taken by at least either the camera 11 of the first terminal device 10, or the camera 11 of the second terminal device 10, or the external camera 60; or when the microphone 12 of the first terminal device 10 of the first user and the microphone 12 of the second terminal device 10 of the second user have recorded a conversation having identical details and when the first terminal device 10 and the second terminal device 10 are placed at a shorter distance from each other than a predetermined threshold value; the conversation processing unit 52 can determine that the first user and the second user are having a conversation in the real space. At Step S20, when it is determined that no conversation is detected between the first user and the second user (No at Step S20), the operations from Step S30 to Step S70 explained below are skipped and the system control proceeds to Step S80.

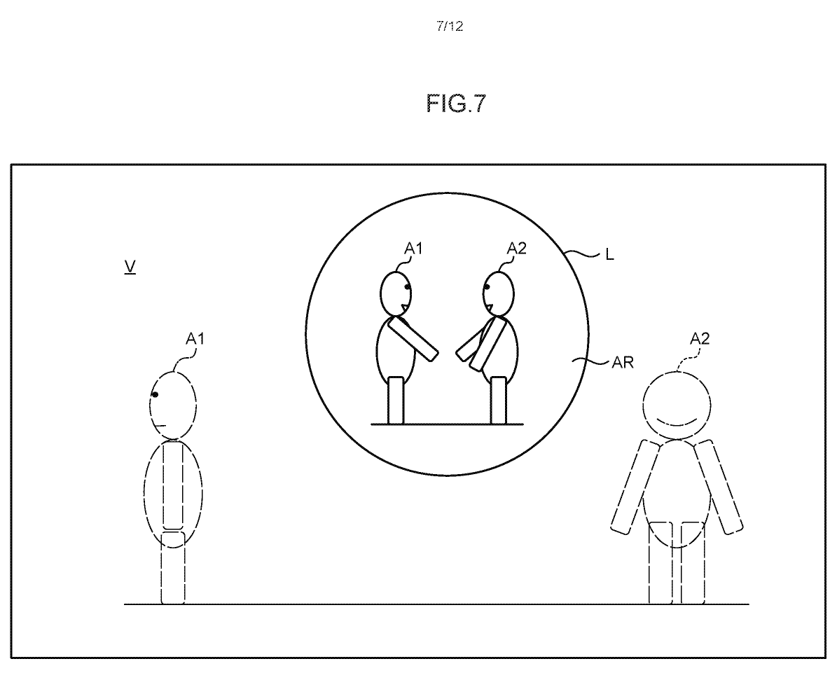

At Step S20, when a conversation between the first user and the second user is detected (Yes at Step S20), as illustrated in FIG. 7, the enclosing region control unit 53 generates the enclosing region AR that encloses the first avatar A1 and the second avatar A2 (Step S30). As illustrated in FIG. 7, at the time of generation of the enclosing region AR, the avatar control unit 51 can change the distance between the first avatar A1 and the second avatar A2 from the distance before the detection of the conversation (Step S40). For example, at the time of generation of the enclosing region AR, the avatar control unit 51 can shorten the distance between the first avatar A1 and the second avatar A2 from the distance before the detection of the conversation. Moreover, in that case, upon changing the distance, the avatar control unit 51 can also change the other conditions such as the positions, the orientations, and the sizes of the first avatar A1 and the second avatar A2 in the virtual space V. Meanwhile, the operations at Steps S30 and S40 can also be performed in reverse order. That is, the control device 50 can firstly change the distance between the first avatar A1 and the second avatar A2 and then form the enclosing region AR.

In the example illustrated in FIG. 7, the enclosing region control unit 53 sets the enclosing region AR to have a circular boundary line L. However, that is not the only possible shape. Alternatively, for example, the enclosing region AR can be formed in some other shape such as an elliptical shape, a cloud shape, a heart shape, or a polygon shape. Still alternatively, the enclosing region AR is not limited to a single shape, and can have a plurality of shapes combined therein. Moreover, the enclosing region AR can be colored in a different color than the other region of the virtual space V. Furthermore, the enclosing region control unit 53 can form a separate window within the virtual space V and can treat that window as the enclosing region AR. Meanwhile, instead of displaying the boundary line L of the enclosing region AR that encloses the first avatar A1 and the second avatar A2, the enclosing region control unit 53 can display a line joining the two avatars or can display the two avatars in the same color.

After the enclosing region AR is formed, the conversation processing unit 52 determines whether or not the details about a third user, who is related to the content of the conversation between the first user and the second user, are included (Step S50). At Step S50, for example, based on the content of the conversation as recognized by the conversation processing unit 25 of the concerned terminal devices 10, the conversation processing unit 52 can determine whether or not the details about a third user are included.

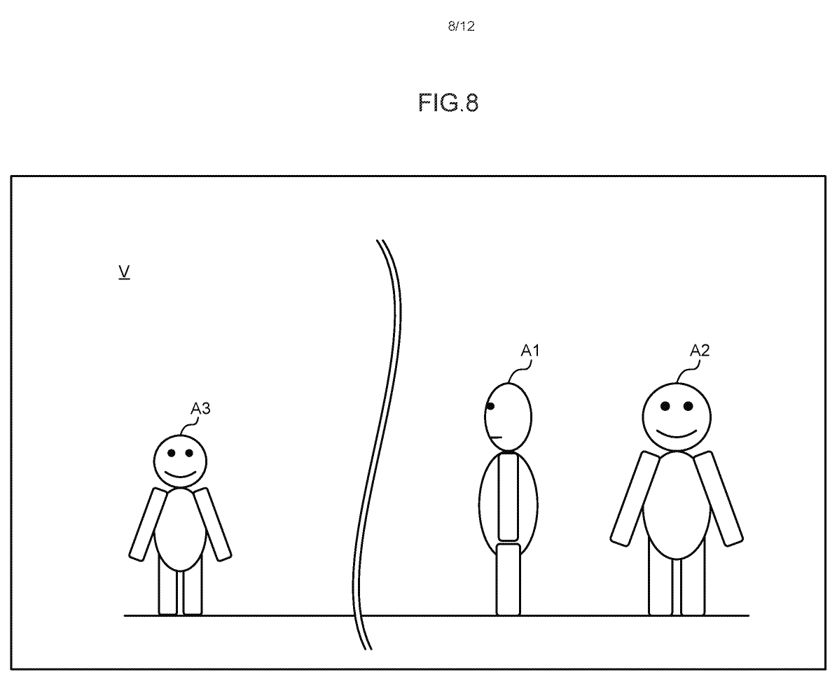

At Step S50, when it is determined that the details about a third user are included (Yes at Step S50), the avatar control unit 51 can determine whether or not a third avatar of that third user is placed in the virtual space V (Step S60). When the third user has logged in to the virtual space V using one of the terminal devices 10, as illustrated in FIG. 8, the avatar control unit 51 places a third avatar A3 of the third user in the virtual space V. On the other hand, at Step S50, when it is determined that the details about the third user are not included (No at Step S50), the operations at Steps S60 and S70 explained below are skipped and the system control proceeds to Step S80.

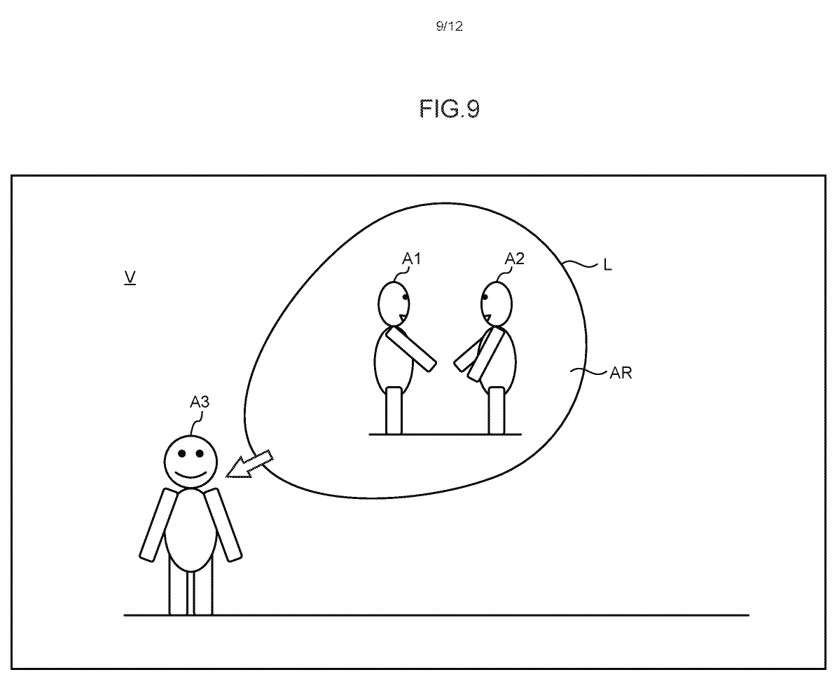

At Step S60, when it is determined that the third avatar A3 of the third user is placed in the virtual space V (Yes at Step S60), as illustrated in FIG. 9, the avatar control unit 51 places the third avatar A3 close to the enclosing region AR in the virtual space V. Moreover, the enclosing region control unit 53 modifies the enclosing region AR in such a way that at least some part of the enclosing region gets closer to the third avatar A3 (Step S70). At Step S70, the enclosing region control unit 53 can modify some part of the boundary line L in such a way that, for example, as illustrated in FIG. 9, the boundary line L of the enclosing region AR moves toward the third avatar A3. However, the example illustrated in FIG. 9 is not the only possible example, and alternatively the enclosing region control unit 53 can modify some part of the enclosing region AR in some other fashion to ensure that the modified part moves toward the third avatar A3. Of the boundary line L of the enclosing region AR, the enclosing region control unit 53 can move the point positioned at the shortest distance from the third avatar A3 toward the third avatar A3. The enclosing region control unit 53 can select some position in the region occupied for the display of the third avatar A3, treat the selected position as the position of the third avatar A3, and calculate the distance between a point on the boundary line L and the third avatar A3. Thus, the enclosing region control unit 53 can move, toward the third avatar A3, such a point on the boundary line L which is positioned at a shorter distance from the third avatar A3 than a predetermined distance. The enclosing region control unit 53 can shorten the distance between the point on the boundary line L and the third avatar A3. Alternatively, the enclosing region control unit 53 can move, toward the third avatar A3, such a plurality of points on the boundary line L which is positioned at a shorter distance from the third avatar A3 than a predetermined distance. Regarding the points on the boundary line L that are positioned at a shorter distance from the third avatar A3 than a predetermined distance; shorter the distance, the greater can be the movement toward the third avatar A3 as controlled by the enclosing region control unit 53. Meanwhile, at Step S60, when it is determined that the third avatar A3 of the third user is not placed in the virtual space V (No at Step S60), the operation at Step S70 explained below is skipped and the system control proceeds to Step S80.

When the enclosing region AR is formed in the virtual space V at Step S30, when the distance between the first avatar A1 and the second avatar A2 is changed at Step S40, and when at least some part of the enclosing region AR is modified to approach the third avatar A3; the display control unit 54 displays the various processing results in the display unit 17 of the terminal device 10 (Step S80).

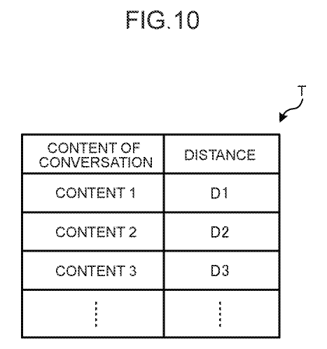

FIGS. 10 to 12 are diagrams illustrating another example of changing the distance between the first avatar A1 and the second avatar A2 at Step S40. FIG. 10 is a diagram illustrating an example of the correspondence relation of the types of conversation between a first user and a second user with the distances between the first avatar A1 and the second avatar A2. As illustrated in FIG. 10, in the memory unit 55 is stored the correspondence information T in which the types of conversation between the first user and the second user are held in a corresponding manner to the distances between the first avatar and the second avatar. Based on the correspondence information T, the avatar control unit 51 can set the distance between the first avatar A1 and the second avatar A2 according to the type of conversation between the first user and the second user.

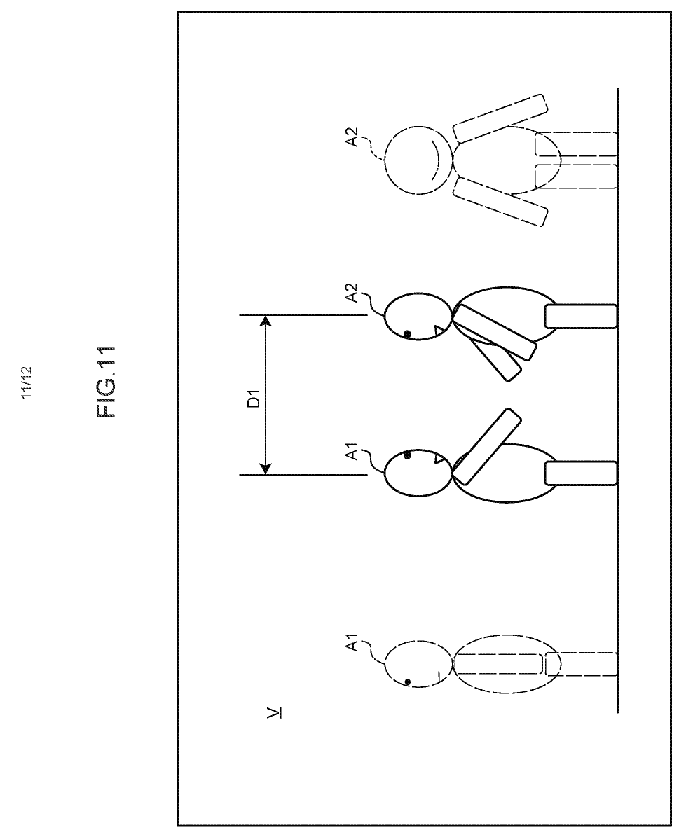

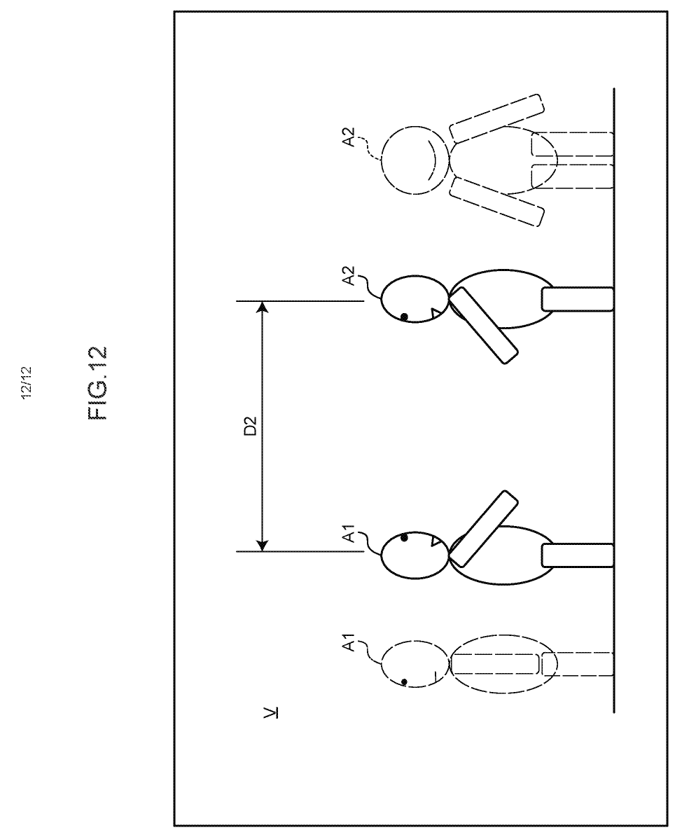

For example, as illustrated in FIG. 11, when the type of conversation indicates work-related topics, the avatar control unit 51 can set a first distance D1 as the distance between the first avatar A1 and the second avatar A2. Moreover, as illustrated in FIG. 12, when the type of conversation indicates private topics, the avatar control unit 51 can set a second distance D2 as the distance between the first avatar A1 and the second avatar A2. In this way, based on the type of conversation between the users in the real space, the distance between the corresponding avatars in the virtual space V can be changed. Hence, any third person who sees the distance between the avatars in the virtual space V becomes able to easily understand the type of conversation. In the correspondence information T, for each type of conversation, the distance D between the avatars either can be kept same or can be kept different. For example, as illustrated in FIG. 12, the distance D2 corresponding to the case in which the type of conversation indicates private topics can be set to be longer than the distance D1 corresponding to the case in which the type of conversation indicates work-related topics. Alternatively, the distance D2 corresponding to the case in which the type of conversation indicates private topics can be set to be shorter than the distance D1 corresponding to the case in which the type of conversation indicates work-related topics. The correspondence information T can also include items such as the color of the enclosing region AR, the color of the boundary line L of the enclosing region AR, the line thickness of the boundary line L, and the line type of the boundary line L. Alternatively, some of the items can be stored in the memory unit 55 in a corresponding manner to the types of conversation. Thus, based on the correspondence information T, the enclosing region control unit 53 can set the enclosing region AR or the boundary line L of the enclosing region AR according to the type of conversation.

As explained above, the virtual space control system 1 according to the present embodiment includes the control device 50 that places the first avatar A1 of a first user, who uses a first terminal 10 in the real space, in the virtual space V and places the second avatar A2 of a second user, who uses a second terminal 10 in the real space, in the virtual space V; that, while the first avatar A1 and the second avatar A2 are placed in the virtual space V, when a conversation between the first user and the second user in the real space is detected, generates, in the virtual region V, the enclosing region AR that encloses the first avatar A1 and the second avatar A2; and that displays the virtual space V in the display units of the terminal devices including the first terminal device 10 and the second terminal device 10.

The virtual space control method according to the present embodiment is implemented by the control device 50 and includes: a step for placing a first avatar A1 of a first user, who uses a first terminal device 10 in the real space, in the virtual space V and placing a second avatar A2 of a second user, who uses a second terminal device 10 in the real space, in the virtual space V; a step by which, while the first avatar A1 and the second avatar A2 are placed in the virtual space V, when a conversation between the first user and the second user in the real space is detected, the enclosing region AR that encloses the first avatar A1 and the second avatar A2 is generated in the virtual region V; and a step for displaying the virtual space V in the display units of the terminal devices including the first terminal device 10 and the second terminal device 10.

A virtual space control program according to the present embodiment causes a computer to execute: an operation of placing a first avatar A1 of a first user, who uses a first terminal device 10 in the real space, in the virtual space V and placing a second avatar A2 of a second user, who uses a second terminal device 10 in the real space, in the virtual space V; an operation by which, while the first avatar A1 and the second avatar A2 are placed in the virtual space V, when a conversation between the first user and the second user in the real space is detected, the enclosing region AR that encloses the first avatar A1 and the second avatar A2 is generated in the virtual region V; and an operation of displaying the virtual space V in the display units of the terminal devices including the first terminal device 10 and the second terminal device 10.

According to such a configuration, while the first avatar A1 and the second avatar A2 are placed in the virtual space V, when a conversation between the first user and the second user in the real space is detected, the enclosing region AR that encloses the first avatar A1 and the second avatar A2 is generated in the virtual region V and is then displayed in the display unit 17 of the terminal device 10. As a result, it can be made easier for a third person to understand the fact that the first user, who corresponds to the first avatar A1 enclosed in the enclosing region AR of the virtual space V, and the second user, who corresponds to the second avatar A2 enclosed in the enclosing region AR of the virtual space V, are having a conversation.

In the virtual space control system 1 according to the present embodiment, when a third user related to the content of the concerned conversation is detected and when the third avatar A3 of the third user is placed in the virtual space V, the control device 50 places the third avatar A3 close to the enclosing region AR and modifies the enclosing region AR in such a way that at least some part of the enclosing region AR gets closer to the third avatar A3.

According to such a configuration, the third user corresponding to the third avatar A3 can be easily made to understand the fact of being related to the conversation between the first user and the second user. As a result, the third user can be encouraged to take part in the conversation.

In the memory unit 55, as the information about a third user, it is possible to store, in advance, the name of the third user, the department to which the third user belongs, and the job description of the third user. The conversation processing unit 52 can determine whether or not the information about the third user as stored in the memory unit 55 is included in the conversation, and accordingly can detect the third user related to the content of the conversation.

When the conversation processing unit 52 detects the conversation between the first user and the second user, the enclosing region control unit 53 can calculate the midpoint of the distance between the first avatar A1 and the second avatar A2, calculate the radius around the midpoint so as to enclose the first avatar A1 and the second avatar A2, and generate the enclosing region AR having a circular shape with the calculated radius.

The avatar control unit 51 can place the third avatar A3 at a position having a predetermined distance from the enclosing region AR. The avatar control unit 51 can calculate the region in the vicinity of the enclosing region AR as the region inside a circle having approximately double the radius of the radius calculated at the time of generating the enclosing region AR.

Meanwhile, instead of the avatar control unit 51 placing the third avatar A3 close to the enclosing region AR, the enclosing region control unit 53 can modify the enclosing region AR in such a way that at least some part of the enclosing region AR gets closer to the third avatar A3. The avatar control unit 51 either can be placed at a position having a predetermined distance from the first avatar A1, or can be placed at a position having a predetermined distance from the second avatar A2. At the time of detecting a third user related to the content of the conversation, when the third user is detected from the voice of the first user, the avatar control unit 51 can place the third avatar A3 at a position having a predetermined distance from the first avatar A1; and, when the third user is detected from the voice of the second user, the avatar control unit 51 can place the third avatar A3 at a position having a predetermined distance from the second avatar A2.

When the placement of the third user, who is related to the content of the conversation, in the virtual space V is not detected, the control device 50 can send a notification to the third user as a reminder to log in to the virtual space V. When the placement of the third user, who is related to the content of the conversation, in the virtual space V is not detected, the control device 50 can automatically log the third user in the virtual space V, and can send a notification to the third user indicating that the login is complete. At that time, the control device 50 can also detect the fact that the third user has a history of logging in to the virtual space V.

In the virtual space control system 1 according to the present embodiment, while the first avatar A1 and the second avatar A2 are placed in the virtual space V, when a conversation between the first user and the second user in the real space is detected, the control device 50 changes the distance between the first avatar A1 and the second avatar A2 from the distance before the detection of the conversation.

According to such a configuration, as a result of changing the distance between the first avatar A1 and the second avatar A2, it can be made easier for a third person to understand the fact that the first user, who corresponds to the first avatar A1, and the second user, who corresponds to the second avatar A2, are having a conversation.

At the time of changing the distance between the first avatar A1 and the second avatar A2, the avatar control unit 51 can change the distance between the avatars by moving only one of the avatars without moving the other avatar. Alternatively, at the time of changing the distance between the first avatar A1 and the second avatar A2, the avatar control unit 51 can calculate the midpoint of the distance between the first avatar A1 and the second avatar A2 and can change the distance between the avatars by moving them around the midpoint. In other words, the avatar control unit 51 can change the distance between the avatars by moving the avatars to positions having a predetermined distance from the calculated midpoint. Meanwhile, instead of using the midpoint, the avatar control unit 51 can use a predetermined position that is within a predetermined distance from the first avatar A1 as well as the second avatar A2.

The virtual space control system 1 according to the present embodiment includes the control device 50 that places the first avatar A1 of a first user, who uses a first terminal 10 in the real space, in the virtual space V and places the second avatar A2 of a second user, who uses a second terminal 10 in the real space, in the virtual space V; that, while the first avatar A1 and the second avatar A2 are placed in the virtual space V, when a conversation between the first user and the second user in the real space is detected, changes the distance between the first avatar A1 and the second avatar A2 from the distance before the detection of the conversation; and that displays the virtual space V in the display units of the terminal devices including the first terminal device 10 and the second terminal device 10.

The virtual space control method according to the present embodiment is implemented by the control device 50 and includes: a step for placing the first avatar A1 of a first user, who uses a first terminal 10 in the real space, in the virtual space V and places the second avatar A2 of a second user, who uses a second terminal 10 in the real space, in the virtual space V; a step by which, while the first avatar A1 and the second avatar A2 are placed in the virtual space V, when a conversation between the first user and the second user in the real space is detected, the distance between the first avatar A1 and the second avatar A2 is changed from the distance before the detection of the conversation; and a step for displaying the virtual space V in the display units of the terminal devices including the first terminal device 10 and the second terminal device 10.

A virtual space control program according to the present embodiment causes a computer to execute: an operation of placing the first avatar A1 of a first user, who uses a first terminal 10 in the real space, in the virtual space V and places the second avatar A2 of a second user, who uses a second terminal 10 in the real space, in the virtual space V; an operation by which, while the first avatar A1 and the second avatar A2 are placed in the virtual space V, when a conversation between the first user and the second user in the real space is detected, the distance between the first avatar A1 and the second avatar A2 is changed from the distance before the detection of the conversation; and an operation of displaying the virtual space V in the display units of the terminal devices including the first terminal device 10 and the second terminal device 10.

According to such a configuration, as a result of changing the distance between the first avatar A1 and the second avatar A2, it can be made easier for a third person to understand the fact that the first user, who corresponds to the first avatar A1, and the second user, who corresponds to the second avatar A2, are having a conversation.

In the virtual space control system 1 according to the present embodiment, the control device 50 stores, in advance, the correspondence information T in which the types of conversation are held in a corresponding manner to the distances between the first avatar A1 and the second avatar A2; and, while the first avatar A1 and the second avatar A2 are placed in the virtual space V, when a conversation between the first user and the second user in the real space is detected, detects the type of conversation and obtains the distance corresponding to the detected type of conversation based on the correspondence information, and then changes the distance between the first avatar A1 and the second avatar A2 to the obtained distance.

According to such a configuration, based on the correspondence information T, the distance between the first avatar A1 and the second avatar A2 can be set according to the content of the conversation between the first user and the second user. As a result, a third person not included in the conversation becomes able to understand the type of conversation. Hence, as compared to the case in which the type of conversation cannot be known, it becomes possible to encourage participation in the conversation.

In the virtual space control system 1 according to the present embodiment, while the first avatar A1 and the second avatar A2 are placed in the virtual space V, when a conversation between the first user and the second user in the real space is detected, the control device 50 generates the enclosing region AR, which encloses the first avatar A1 and the second avatar A2, in the virtual space V.

According to such a configuration, it can be made easier for a third person to understand the fact that the first user, who corresponds to the first avatar A1 enclosed in the enclosing region AR of the virtual space V, and the second user, who corresponds to the second avatar A2 enclosed in the enclosing region AR of the virtual space V, are having a conversation.

According to the present invention, it becomes easier to understand the communication among the avatars in a virtual space.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A virtual space control system comprising a control device that
places, in a virtual space, a first avatar of a first user, who uses a first terminal in real space, and a second avatar of a second user, who uses a second terminal in the real space,
while the first avatar and the second avatar are placed in the virtual space, when a conversation between the first user and the second user in the real space is detected, generates, in the virtual space, an enclosing region which encloses the first avatar and the second avatar, and
displays the virtual space in display units of terminal devices including the first terminal device and the second terminal device.

2. The virtual space control system according to claim 1, wherein
when a third user is detected who is related to content of the conversation and when it is detected that a third avatar of the third user is placed in the virtual space, the control device places the third avatar at a position having predetermined distance from the enclosing region, and
the control device modifies the enclosing region in such a way that at least some part of the enclosing region gets closer to the third avatar.

3. The virtual space control system according to claim 1, wherein,
while the first avatar and the second avatar are placed in the virtual space, when a conversation between the first user and the second user in the real space is detected, the control device changes distance between the first avatar and the second avatar from distance before detection of the conversation.

4. A virtual space control method implemented by a control device, comprising:
placing, in a virtual space, a first avatar of a first user, who uses a first terminal in real space, and a second avatar of a second user, who uses a second terminal in the real space;
generating that, while the first avatar and the second avatar are placed in the virtual space, when a conversation between the first user and the second user in the real space is detected, includes generating, in the virtual space, an enclosing region which encloses the first avatar and the second avatar; and
displaying the virtual space in display units of terminal devices including the first terminal device and the second terminal device.

5. A virtual space control system comprising a control device that
places, in a virtual space, a first avatar of a first user, who uses a first terminal in real space, and a second avatar of a second user, who uses a second terminal in the real space,
while the first avatar and the second avatar are placed in the virtual space, when a conversation between the first user and the second user in the real space is detected, changes distance between the first avatar and the second avatar from distance before detection of the conversation,
displays the virtual space in display units of terminal devices including the first terminal device and the second terminal device.

6. The virtual space control system according to claim 5, wherein the control device
stores correspondence information in which type of the conversation is held in a corresponding manner to distance between the first avatar and the second avatar, and
while the first avatar and the second avatar are placed in the virtual space, when a conversation between the first user and the second user in the real space is detected, detects type of the conversation, obtains the distance corresponding to the detected type of the conversation based on the correspondence information, and changes distance between the first avatar and the second avatar to the obtained distance.

7. The virtual space control system according to claim 6, wherein, while the first avatar and the second avatar are placed in the virtual space, when a conversation between the first user and the second user in the real space is detected, the control device generates, in the virtual space, an enclosing region which encloses the first avatar and the second avatar.
